(19) United States
(12) Patent Application Publication
(10) Pub. No.: US 2025/0271019 A1
(43) Pub. Date: Aug. 28, 2025

(54) DUAL-END FASTENING BOLT

(71) Applicant: International Truck Intellectual Property Company, LLC, Lisle, IL (US)

(72) Inventors: Emma Langer, Naperville, IL (US); Hector Kiely, Plainfield, IL (US); Stephen Burd, Lombard, IL (US)

(73) Assignee: International Truck Intellectual Property Company, LLC, Lisle, IL (US)

(21) Appl. No.: 18/585,155

(22) Filed: Feb. 23, 2024

(51) Int. Cl. F16B 23/00

(52) U.S. Cl. CPC F16B 23/0038

(57) ABSTRACT

A dual-end fastening bolt is provided. In one embodiment, the dual-end fastening bolt comprises a head at a first end of the dual-end fastening bolt, a tail at a second end of the dual-end fastening bolt opposite the head, a shank extending from the head to the tail and comprising a threaded portion, wherein the tail comprises a tool feature engageable with a tool to rotate the dual-end fastening bolt or to prevent the dual-end fastening bolt from rotation.

### FIELD

The present disclosure generally relates to fastening technologies. More particularly, embodiments described herein relate to a dual-end fastening bolt.

### BACKGROUND

Some technologies that rely on components being coupled and uncoupled from one another utilize fasteners instead of more permanent attachment solutions like welding, soldering, and adhesives. Fastener design may be driven by specific need, including how often components are decoupled, strength or nature of component coupling, ease of use, and so forth.

Yet some fasteners may be limited in their applicability, such as bolts and nuts used to secure objects together or in place. For instance, a bolt may be inserted through various openings in vehicle components to be fastened together, and a nut may then be screwed on bolt threading, thereby securing the vehicle components together. Depending on the nature of the vehicle components and their environment, fastening or unfastening bolts may be cumbersome, difficult, or even risky. For example, bolts may be used to secure a passenger seat to a vehicle floor. The bolts may be inserted from one side of the vehicle floor into openings in the passenger seat and vehicle floor, and secured by fastening nuts on the other side of the vehicle floor. While possibly more straightforward during vehicle manufacturing, such two-sided fastening approach may present difficulties during maintenance or repair due to limited access or obstruction by other components already installed. For example, a two-sided fastening approach may not allow for yearly tightening of passenger seat floor bolts on an electric bus without displacing or removing vehicle batteries. Yet periodic displacement or removal of vehicle batteries may be dangerous, and often not advisable. Also, while passenger seats may be secured to a vehicle floor using additional components, like tracks or stud plates attached to the vehicle floor, such additional components may present certain limitations or drawbacks, such as increased vehicle weight, reduced capacity, additional labor, increases cost, reduced availability for additional components (e.g., under seat heaters), and so forth.

Therefore, a need exists for improved fastening approaches and fasteners with broader applicability.

### SUMMARY

A dual-end fastening bolt is provided. In one embodiment, the dual-end fastening bolt comprises a head at a first end of the dual-end fastening bolt, a tail at a second end of the dual-end fastening bolt opposite the head, a shank extending from the head to the tail and comprising a threaded portion, wherein the tail comprises a tool feature engageable with a tool to rotate the dual-end fastening bolt or to prevent the dual-end fastening bolt from rotation.

In another embodiment, the dual-end fastening bolt comprises a head at a first end of the dual-end fastening bolt comprising a first tool feature, a tail at a second end of the dual-end fastening bolt opposite the head comprising a second tool feature, and a shank that extends from the head to the tail and comprises a threaded portion, wherein the first tool feature is engageable with a first tool to rotate the dual-end fastening bolt or to prevent the dual-end fastening bolt from rotation, and the second tool feature is engageable with a second tool to rotate the dual-end fastening bolt or to prevent the dual-end fastening bolt from rotation.

### BRIEF DESCRIPTION OF THE DRAWINGS

FIG. 1A is a perspective view of a dual-end fastening bolt, according to one embodiment described herein;

FIG. 1B is a side view of the dual-end fastening bolt shown in FIG. 1A;

FIG. 2A is a side view of an example dual-end fastening bolt, according to one embodiment described herein;

FIG. 2B is a bottom view of the dual-end fastening bolt shown in FIG. 2A;

FIG. 2C is cross-sectional view along line A-A′ on the dual-end fastening bolt shown in FIG. 2B;

FIG. 3A is a bottom view of another example dual-end fastening bolt, according to one embodiment described herein;

FIG. 3B is a bottom view of yet another example dual-end fastening bolt, according to one embodiment described herein;

FIG. 3C is a bottom view of yet another example dual-end fastening bolt, according to one embodiment described herein;

FIG. 3D is a bottom view of yet another example dual-end fastening bolt, according to one embodiment described herein;

FIG. 3E is a bottom view of yet another example dual-end fastening bolt, according to one embodiment described herein;

FIG. 3F is a bottom view of yet another example dual-end fastening bolt, according to one embodiment described herein;

FIG. 4A is a side view of another example dual-end fastening bolt, according to one embodiment described herein;

FIG. 4B is a bottom view of the dual-end fastening bolt shown in FIG. 4A;

FIG. 4C is cross-sectional view along line B-B′ on the dual-end fastening bolt shown in FIG. 4B;

FIG. 5A is a bottom view of another example dual-end fastening bolt, according to one embodiment described herein;

FIG. 5B is a bottom view of yet another example dual-end fastening bolt, according to one embodiment described herein;

FIG. 5C is a bottom view of yet another example dual-end fastening bolt, according to one embodiment described herein;

FIG. 5D is a bottom view of yet another example dual-end fastening bolt, according to one embodiment described herein;

FIG. 5E is a bottom view of yet another example dual-end fastening bolt, according to one embodiment described herein;

FIG. 6 is an illustration showing an example use case for a dual-end fastening bolt, according to embodiments described herein;

FIG. 7A is a side view of yet another example dual-end fastening bolt, according to one embodiment described herein;

FIG. 7B is a side view of yet another example dual-end fastening bolt, according to one embodiment described herein.

### DETAILED DESCRIPTION

Conventional fasteners used secure objects may be limited in their use. The present disclosure provides a dual-end fastening bolt that allows one or more objects to be secured together or in place with greater flexibility, and at reduced cost and risk.

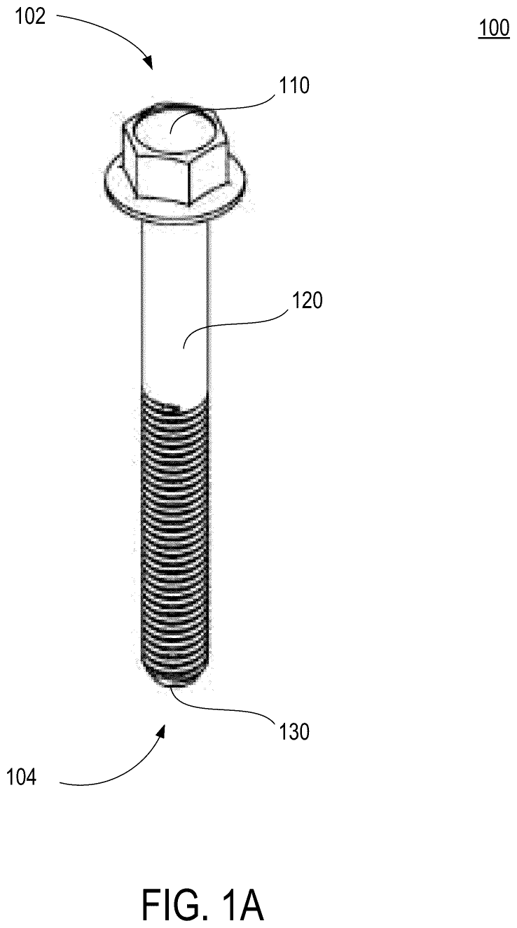

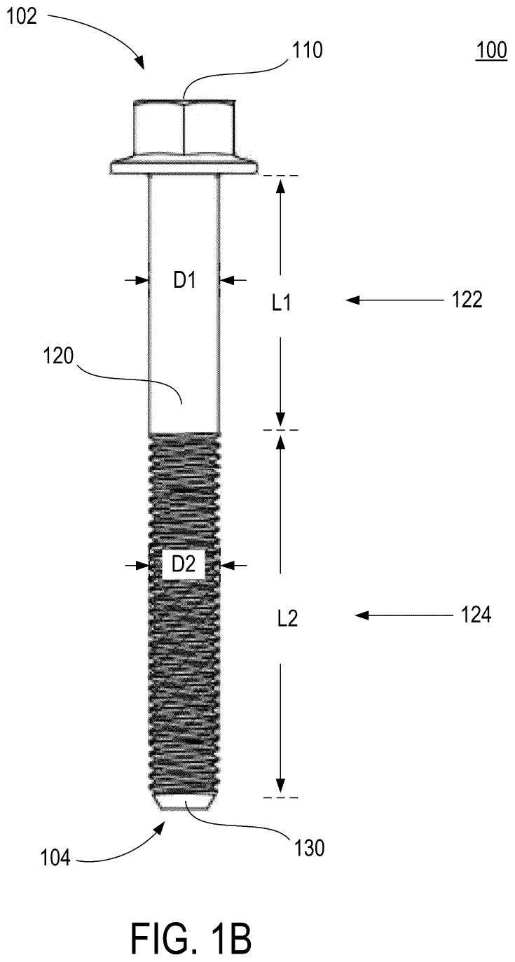

Turning to FIGS. 1A and 1i, an example dual-end fastening bolt 100 is illustrated, according to some embodiments. In general, the dual-end fastening bolt 100 extends from a first end 102 to a second end 104, and includes a head 110 at the first end 102, a shank 120, and a tail 130 opposite the head 110 at the second end 104, where the shank 130 extends from the head 110 to the tail 130. The dual-end fastening bolt 100, in accordance with embodiments described herein, may be made and/or coated using any materials or combinations of materials. For example, the dual-end fastening bolt 100 may include various metals, polymers, plastics, ceramics, adhesives, epoxies, sealants, lubricants, and so forth.

In some implementations, the head 110 may be used to manipulate, position, or hold the dual-end fastening bolt 100 in order to secure one or more objects. For instance, the head 110 may be used to rotate the dual-end fastening bolt 100 and/or prevent the dual-end fastening bolt 110 from rotation. As such, the head 110 may be capable of engaging with various components, attachments, and tools, such as a screwdriver, a socket, a wrench, a rachet, an Allen key, a pin, a tip, and so forth. As illustrated in FIGS. 1A-1B, the head 110 may be a hexagonal (“hex”) head. However, the head 110 may have any shape, dimensions, and features. In some embodiments, the head 110 may include various surfaces, textures, recesses, openings, flanges, slots, bevels, tapers, ridges, chamfers, collars, washers, nuts, indicators, and other features. In some non-limiting examples, the head 110 may be a square head, a washer head, a socket head, a pan head, a cup head, a binding head, a fillister head, a flanged head, a round head, an oval head, a flat head, a countersunk head, a truss head, a cheese head, an eye bolt head, a T-head, a winged head, and so forth.

As shown in FIGS. 1A-1, in some embodiments, the shank 120 may include a non-threaded portion 122 and a threaded portion 124. At least a portion of the non-threaded portion 122 may have a dimeter D1 between approximately 0.1″ and approximately 3″ and a length L1 between approximately 0.1″ and approximately 3″, although other diameter and length values, in any combination, may be possible. The threaded portion 124 may have a diameter D2 between approximately 0.1″ and approximately 3″, a length L2 between approximately 0.5″ and approximately 10″, and a pitch approximately between 1 and 30 threads per inch, although other diameter, length, and pitch values, in any combination, may be possible. The threaded portion 124 may then engage a nut or any other element, component, or attachment having threads matching threads on the threaded portion 124 of the shank 120, thereby allowing one or more objects to be secured. In some embodiments, the threaded portion 124 of the shank 120 extends to the tail 130 of the dual-end fastening bolt 100, as illustrated in FIGS. 1A-1B. However, the shank 120, non-threaded portion 122, and/or threaded portion 124 may have any shape, dimensions, and features. For instance, in some embodiments, the shank 120 may include a threaded portion 124 that extends from the head 110 to the tail 130. In other embodiments, the shank 120 may include more than one threaded portion 124, with each threaded portion 124 having a different set of threads, such as a different pitch, length L2, diameter D2, or any combination thereof. In yet other embodiments, the shank 120 may include various surfaces, recesses, openings, protrusions, slots, bevels, tapers, indicators, chamfers, collars, washers, nuts, as well as other features. Herein, the terms “approximately” or “about” used in reference to a numerical value refer to the numerical value and values within an error margin or tolerance of up 10% of the numerical value.

The tail 130 of the dual-end fastening bolt 100 may also be used manipulate, position, or hold the dual-end fastening bolt 100 in order to secure one or more objects. As described in further detail below, in some embodiments, the tail 130 includes a tool feature that may engage a tool to rotate the dual-end fastening bolt 100 or to prevent the dual-end fastening bolt 100 from rotation. As appreciated from description herein, such tool feature provides a number of advantages, including the ability to fasten and unfasten the dual-end fastening bolt 100 securely from either end, and without damage to the threaded portion 124 of the dual-end fastening bolt 100, for example.

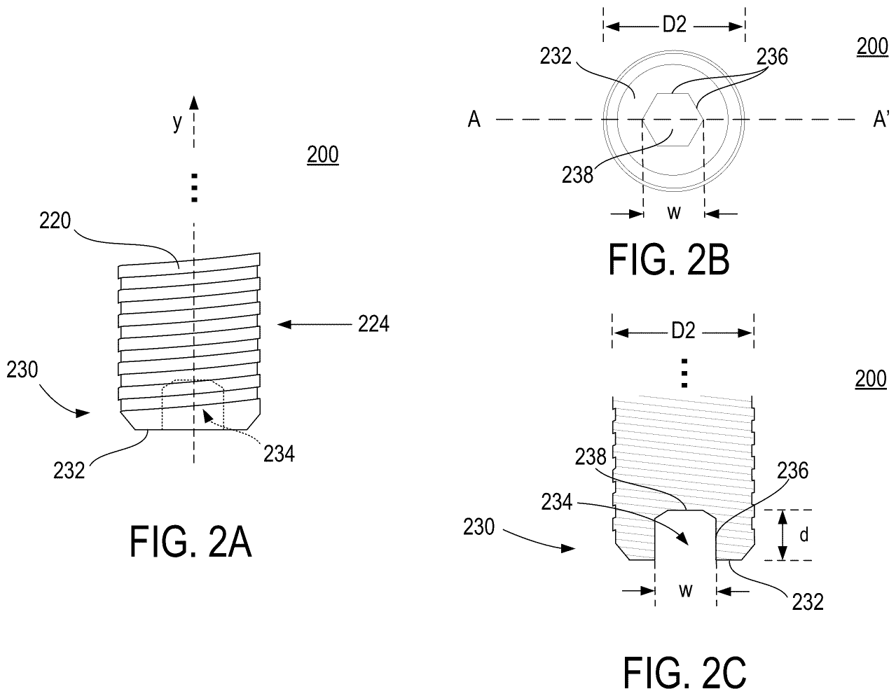

Referring to FIGS. 2A-2C, an example dual-end fastening bolt 200 is illustrated, according to some embodiments. The dual-end fastening bolt 200 may include a head (not shown), a shank 220 including a non-threaded portion 224, and a tail 230. In some embodiments, as shown in FIG. 2A, the tail 230 may extend from, or may be connected to, the threaded portion 224. The tail 230 may include a tail bottom surface 232 that is perpendicular to the longitudinal axis y of the dual-end fastening bolt 200, and a fastening recess 234 that extends inside the tail 230 from the tail bottom surface 232.

In some implementations, the fastening recess 234 may be used to manipulate, position, or hold the dual-end fastening bolt 200 in order to secure one or more objects. Hence, in some embodiments, the fastening recess 234 may be shaped and dimensioned to receive at least a portion of a component, attachment, and/or tool, such as a screwdriver, a socket, a wrench, a rachet, an Allen key, a pin, a bit, and so forth. For instance, as shown in the example of FIGS. 2A-2C, the fastening recess 234 may be a hexagonal recess defined by a number of recess walls 236 and a recess bottom surface 238. As such, the fastening recess 234 may have a width w between approximately 0.1″ and approximately 2″ measured across corners of a hexagon, and may extend inside the tail 230 for a depth d between approximately 0.1″ and approximately 1″, although other width and depth values may be possible.

In some embodiments, the fastening recess 234 may include one or more features that may help receive, accommodate, or secure the portion of the component, attachment, and/or tool used to manipulate, position, or hold the dual-end fastening bolt 200. For instance, in one example shown in FIGS. 2A and 2C, the fastening recess 234 may be beveled at the recess bottom surface 238 to accommodate a portion of a component, attachment, tool, or portion thereof. In another example, an opening of the fastening recess 234, formed by the tail bottom surface 232 and the recess walls 236, may be chamfered to allow for easier entry of a component, attachment, tool, or portion thereof, in the fastening recess 234.

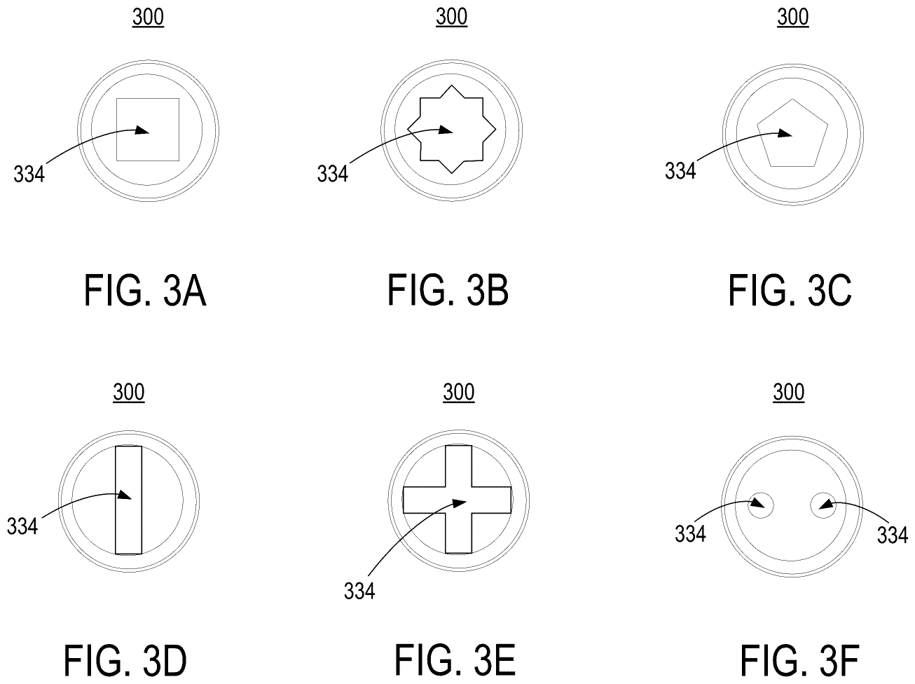

Although FIGS. 2A-2C show one example of the tail 230 and the fastening recess 234, configurations and features of the dual-end fastening bolt 200 are not so limited. For instance, the recess bottom surface 238 and/or recess walls 236 need not be flat or straight as shown in FIGS. 2A and 2C, but may be rounded, curved, pitted, slotted, and so forth. Also, the fastening recess 234 need not be a hexagonal recess as shown in FIG. 2B, but may have a variety of shapes and dimensions. Moreover, the tail 230 may include more than one fastening recess 234. For instance, and for purposes of illustration, FIGS. 3A-3F show a few non-limiting examples of a dual-end fastening bolt 300, where the fastening recess 334 may be a square recess (FIG. 3A), a double square recess (FIG. 3B), a pentagonal recess (FIG. 3C), a slotted recess (FIG. 3D), a crossed or Phillips recess (FIG. 3E), or a Spanner recess (FIG. 3F). Other non-limiting examples include a Torx recess, a tri-wing recess, a spline recess, a clutch recess, a polydrive recess, a pentalobe recess, a triangular recess, a tri-point recess, a tri-wing recess, a clutch recess, a Posidriv recess, a rhomboidal recess, an oval recess, a curvilinear recess, an irregular recess, and so forth.

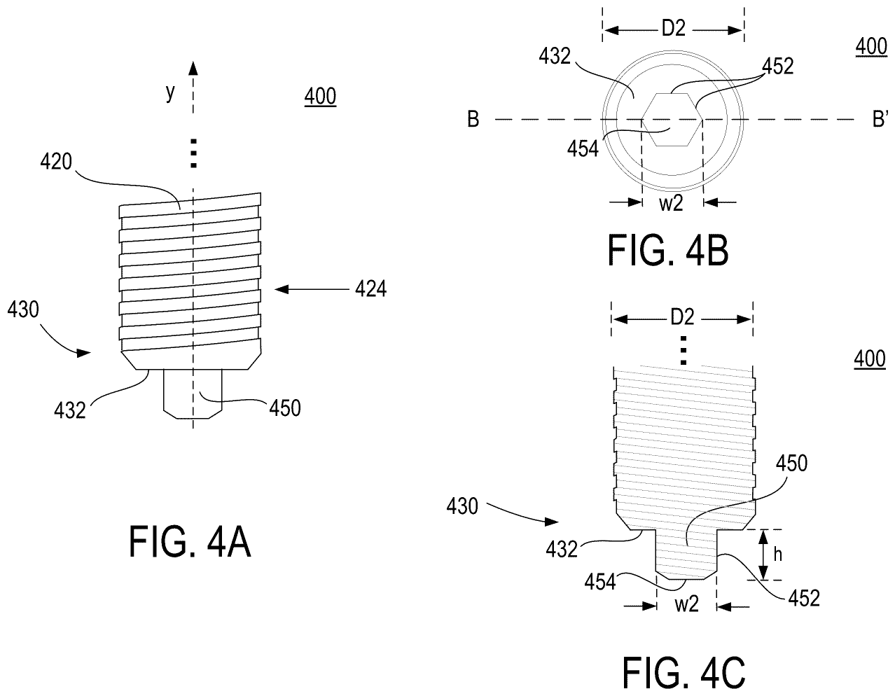

Turning to FIGS. 4A-4C, another example of a dual-end fastening bolt 400, according to some embodiments, is illustrated. The dual-end fastening bolt 400 may include a shank 420, with a non-threaded portion 424, and a tail 430. In some embodiments, as shown in FIG. 4A, the tail 430 may extend from, or may be connected to, the threaded portion 424. The tail 430 may include a tail bottom surface 432 that is perpendicular to the longitudinal axis y of the dual-end fastening bolt 400, and a fastening post 450 that extends from the tail bottom surface 432 and away from a head (not shown) of the dual-end fastening bolt 400.

In some implementations, the fastening post 450 may be used to manipulate, position, or hold the dual-end fastening bolt 400 in order to secure one or more objects. Hence, in some embodiments, the fastening post 450 may be shaped and dimensioned to engage with at least a portion of a component and/or tool, such as a wrench, a socket, a rachet, pliers and so forth. For instance, as shown in the example of FIGS. 4A-4C, the fastening post 450 may be a hexagonal post defined by a number of post walls 452 and a post top surface 454. As such, the fastening post 450 may have a width w2 between approximately 0.1″ and approximately 2″ measured across corners of a hexagon, and may extend for a height h between approximately 0.1″ and approximately 1″, although other width and height values may be possible.

In some embodiments, the fastening post 450 may include one or more features that may help receive, accommodate, or secure a portion of a component, attachment, and/or tool used to manipulate, position, or hold the dual-end fastening bolt 400. For instance, in one example shown in FIGS. 4A and 4C, the fastening post 450 may be beveled or chamfered at the post top surface 454 to facilitate a positioning of a component, attachment, and/or tool on or about the fastening post 450. In another example, at least one of the post walls 452 may be grooved, slotted, or textured to prevent slippage of a component, attachment, and/or tool from the fastening post 450.

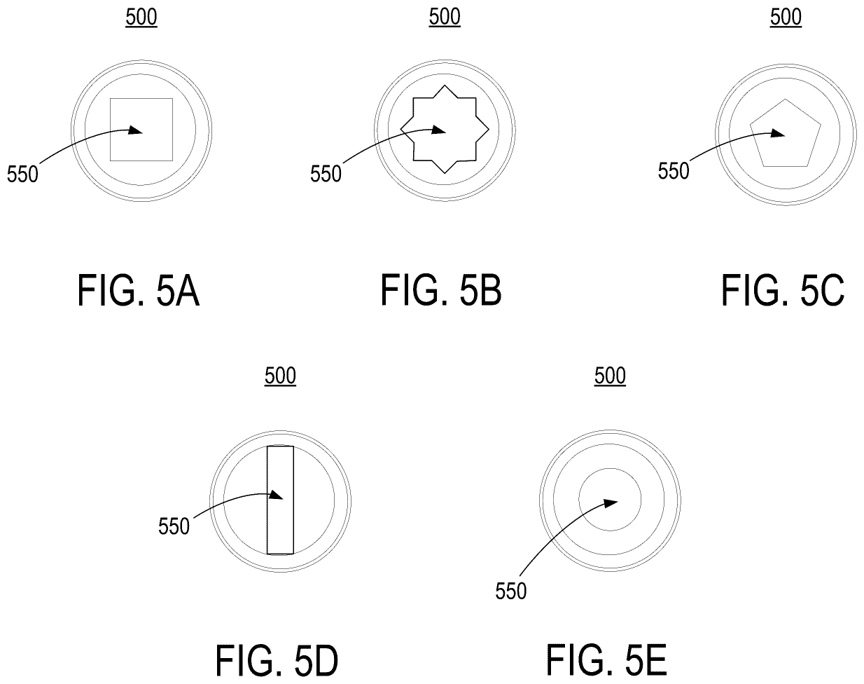

Although FIGS. 4A-4C show one example of the tail 430 and the fastening post 450, configurations and features of the dual-end fastening bolt 400 are not so limited. For instance, the post top surface 454 and/or post walls 452 need not be flat as shown in FIGS. 4A and 4C, but may be rounded, pitted, slotted, domed, and so forth. Furthermore, the fastening post 450 need not be a hexagonal post as shown in FIG. 4B, but may have a variety of shapes and dimensions. For instance, and for purposes of illustration, FIGS. 5A-5F show a few non-limiting examples of a dual-end fastening bolt 500, where the fastening post 550 may be a square post (FIG. 5A), a double square post (FIG. 5B), a pentagonal post (FIG. 5C), a flat or rectangular post (FIG. 5D), a round post (FIG. 5E).

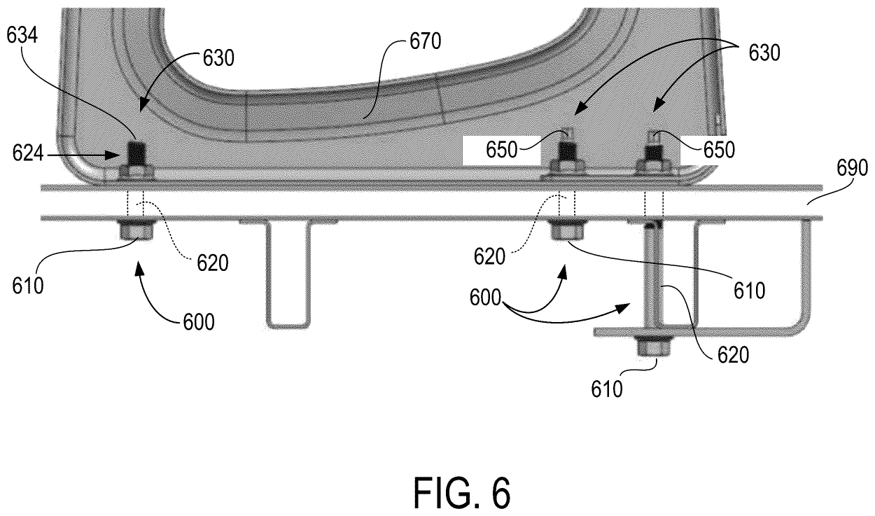

Turning to FIG. 6, an example use case for a dual-end fastening bolt 600, according to embodiments described herein, is shown. In general, the dual-end fastening bolt 600 may include a head 610, a shank 620 extending from the head 610, and a tail 630 opposite the head 610. In some embodiments, the shank 620 includes a threaded portion 624, and the tail 630 includes a fastening feature that may include a fastening recess 634 or a fastening post 650.

As illustrated, a number of dual-end fastening bolts 600 may be used to secure a seat 670 to a floor 690. In some implementations, a dual-end fastening bolt 600 may secure the seat 670 to the floor 690 by threading a nut onto the threaded portion 624 of the dual-end fastening bolt 600. The nut, the head 610, or both may then be rotated or counter-rotated to secure the seat 670 to the floor 690. However, in some scenarios, gaining access to the head 610 of the dual-end fastening bolt 600 under the floor 690 may not be possible, safe, or convenient. For example, access to space beneath the floor 690 during maintenance operations may involve removing certain components (e.g., electric batteries) and may pose a risk, increase cost and time.

Therefore, in some implementations, the dual-end fastening bolt 600 may be fastened using a fastening feature, as described herein. In particular, the nut, fastening feature, or both may be rotated and/or counter-rotated to secure the seat 670 to the floor 690. For example, the fastening feature may be a fastening recess 634 that may receive at least a portion of a component, attachment, and/or tool, which may then apply a force to rotate the dual-end fastening bolt 600 or to prevent the dual-end fastening bolt 600 from rotation. Similarly, the fastening feature may be a fastening post 650 that may engage at least a portion of a component, attachment, and/or tool, which may then apply a force to rotate the dual-end fastening bolt 600 or to prevent the dual-end fastening bolt 600 from rotation. As appreciated from this example, one advantage of the dual-end fastening bolt 600 is the ability to manipulate, position, or hold the dual-end fastening bolt 600 from either end, providing for greater flexibility and usage.

The application, manner, and use of the dual-end fastening bolts 600 shown in FIG. 6 is not particularly limited. For instance, the seat 670 may include a single seat, a double seat, a bench, a stool, and so forth. Similarly, the surface or object to which the seat 670 may be secured is not particularly limited and may, for example, include a vehicle floor, an airplane floor, a train floor, as well as a building structure, a wall, a ceiling, a sidewalk, and so forth. In addition, usage of the dual-end fastening bolts 600 need not be limited to passenger restraint or vehicle components. Hence, various objects may be secured using a dual-end fastening bolt 600, as described. As non-limiting examples, objects that may be secured include a table, a light fixture, a support beam, a hand railing, a shelf, a duct, a fan, a light fixture, a pipe, a board, a painting, and so forth. Furthermore, while three dual-end fastening bolts 600 are shown in FIG. 6 being used secure the seat 670, any number of dual-end fastening bolts 600 can be used to secure any object, including a single dual-end fastening bolt 600. Also, while FIG. 6 shows multiple dual-end fastening bolts 600 being used to secure a single object, namely the seat 670, a single dual-end fastening bolt 600 may be used to secure a single object (i.e., the seat 670).

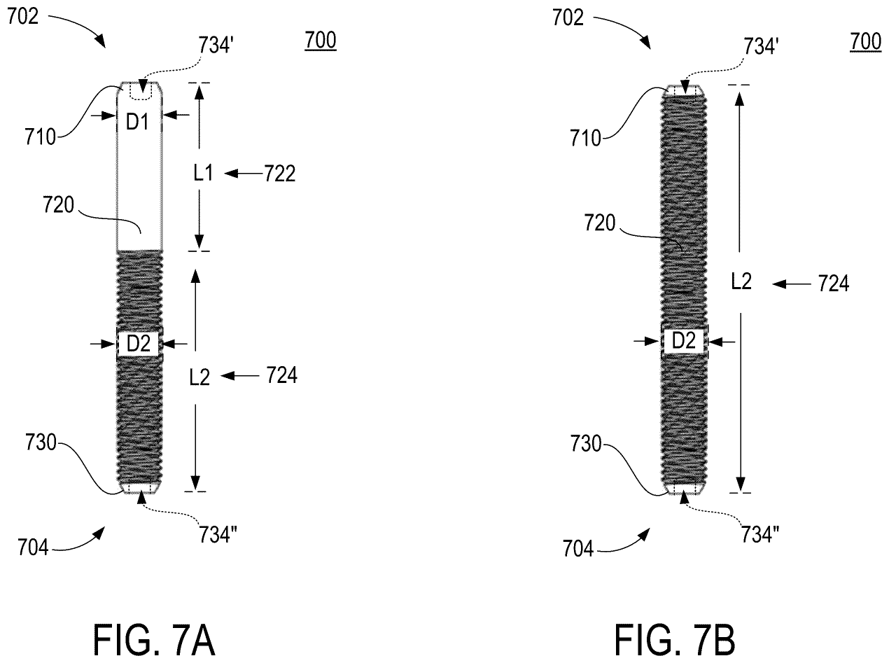

Turning to FIGS. 7A-7B, another example of a dual-end fastening bolt 700, according to some embodiments, is illustrated. The dual-end fastening bolt 700 extends from a first end 702 to a second end 704, and includes a head 710 at the first end 702, a shank 720, and a tail 730 opposite the head 710 at the second end 704, where the shank 730 extends from the head 710 to the tail 730. As illustrated in FIG. 7A, in some embodiments, the shank 720 includes a non-threaded portion 722 and a threaded portion 724. In other embodiments, the shank 720 includes only a threaded portion 724 that extends from the head 710 to the tail 730, as illustrated in FIG. 7B. As described with reference to FIGS. 1A-1B, the shank 720, non-threaded portion 722, and/or threaded portion 724 may have any shape, dimensions, and features. Further, the dual-end fastening bolt 700 may secure various objects, for instance, by engaging one or more nut, element, component, or attachment having threads matching threads on the threaded portion 724.

In some embodiments, the head 710 may include a first tool feature engageable with a first tool to rotate the dual-end fastening bolt 700 or to prevent the dual-end fastening bolt 700 from rotation. The tail 730 may also include a second tool feature engageable with a second tool to rotate the dual-end fastening bolt 700 or to prevent the dual-end fastening bolt from rotation 700. As illustrated in FIGS. 7A-7B, the first tool feature may include a first fastening recess 734′, and the second tool feature may include a second fastening recess 734″. As described with reference to FIGS. 2A-2C, the first fastening recess 734′ and/or second fastening recess 734″ may be used to manipulate, position, or hold the dual-end fastening bolt 700 in order to secure one or more objects. To this end, the first fastening recess 734′ and/or second fastening recess 734″ may be shaped and dimensioned to receive at least a portion of a component, attachment, and/or tool.

The first fastening recess 734′ and the second fastening recess 734″ are illustrated in FIGS. 7A-7B as being similar. To this end, the first tool and the second tool may also be similar. However, it may be appreciated that shapes, dimensions, features, and/or configurations of each fastening recess 734 on the dual-end fastening bolt 700 may vary. For instance, in one non-limiting example, the first fastening recess 734′ may be a hexagonal recess, while the second fastening recess 734″ may be a square recess, as described with reference to FIGS. 2B and 3A. As such, the first tool and the second tool may be different. In addition, while FIGS. 7A and 7B show the first tool feature at the head 710 as the first fastening recess 734′, and the second tool feature at the tail 730 as the second fastening recess 734″, it may be appreciated that the first tool feature, the second tool feature, or both may include a fastening post, as described with reference to FIGS. 4A-C and FIGS. 5A-5E.

According to one embodiment, a dual-end fastening bolt is provided. The dual-end fastening bolt comprises a head at a first end of the dual-end fastening bolt, a tail at a second end of the dual-end fastening bolt opposite the head, and a shank that extends from the head to the tail and comprises a threaded portion, wherein the tail comprises a tool feature engageable with a tool to rotate the dual-end fastening bolt or to prevent the dual-end fastening bolt from rotation. The dual-end fastening bolt of claim 1, wherein the threaded portion extends to the tail of the dual-end fastening bolt. In one embodiment, the head comprises a hexagonal head. In another embodiment, the tool feature comprises a fastening recess that receives at least a portion of the tool, wherein the fastening recess extends to a depth inside the tail. In yet another embodiment, the fastening recess is a hexagonal recess defined by a number of recess walls and a recess bottom surface. In yet another embodiment, the fastening recess is beveled at the recess bottom surface. In yet another embodiment, the tool feature comprises a fastening post that engages at least a portion of the tool, wherein the fastening post extends to a height from a tail bottom surface. In yet another embodiment, the fastening post is a hexagonal post defined by a number of post walls and a post top surface. In yet another embodiment, the fastening post is beveled at the post top surface.

According to another embodiment, a dual-end fastening bolt is provided. The dual-end fastening bolt comprises a head at a first end of the dual-end fastening bolt that comprises a first tool feature, a tail at a second end of the dual-end fastening bolt opposite the head that comprises a second tool feature, and a shank that extends from the head to the tail and comprises a threaded portion, wherein the first tool feature is engageable with a first tool to rotate the dual-end fastening bolt or to prevent the dual-end fastening bolt from rotation, and the second tool feature is engageable with a second tool to rotate the dual-end fastening bolt or to prevent the dual-end fastening bolt from rotation. In one embodiment, the first tool feature comprises a first fastening recess that receives at least a portion of the first tool, or the second tool feature comprises a second fastening recess that receives at least a portion of the second tool, or both. In another embodiment, the first fastening recess, the second fastening recess, or both, includes a hexagonal recess defined by a number of recess walls and a recess bottom surface. In yet another embodiment, the first tool feature comprises a first fastening post that engages at least a portion of the first tool, or the second feature comprises a second fastening post that engages at least a portion of the second tool, or both. In yet another embodiment, the first fastening post, the second fastening post, or both, includes a hexagonal post defined by a number of post walls and a post top surface.

While the present disclosure has described a number of embodiments and implementations, the disclosure is not so limited but covers various obvious modifications and equivalent arrangements, which fall within the purview of the appended claims. Although certain features are expressed in certain combinations among the claims, it is contemplated that these features can be arranged in any combination and order. It should be appreciated that many equivalents, alternatives, variations, and modifications, aside from those expressly stated, are possible.

1. A dual-end fastening bolt comprising:
a head at a first end of the dual-end fastening bolt;
a tail at a second end of the dual-end fastening bolt opposite the head; and
a shank that extends from the head to the tail and comprises a threaded portion, wherein
the tail comprises a tool feature engageable with a tool to rotate the dual-end fastening bolt or to prevent the dual-end fastening bolt from rotation.

2. The dual-end fastening bolt of claim 1, wherein the threaded portion extends to the tail of the dual-end fastening bolt.

3. The dual-end fastening bolt of claim 1, wherein the head comprises a hexagonal head.

4. The dual-end fastening bolt of claim 1, wherein the tool feature comprises a fastening recess that receives at least a portion of the tool, wherein the fastening recess extends to a depth inside the tail.

5. The dual-end fastening bolt of claim 4, wherein the fastening recess is a hexagonal recess defined by a number of recess walls and a recess bottom surface.

6. The dual-end fastening bolt of claim 5, wherein the fastening recess is beveled at the recess bottom surface.

7. The dual-end fastening bolt of claim 1, wherein the tool feature comprises a fastening post that engages at least a portion of the tool, wherein the fastening post extends to a height from a tail bottom surface.

8. The dual-end fastening bolt of claim 7, wherein the fastening post is a hexagonal post defined by a number of post walls and a post top surface.

9. The dual-end fastening bolt of claim 8, wherein the fastening post is beveled at the post top surface.

10. A dual-end fastening bolt comprising:
a head at a first end of the dual-end fastening bolt that comprises a first tool feature;
a tail at a second end of the dual-end fastening bolt opposite the head that comprises a second tool feature; and
a shank that extends from the head to the tail and comprises a threaded portion, wherein
the first tool feature is engageable with a first tool to rotate the dual-end fastening bolt or to prevent the dual-end fastening bolt from rotation, and the second tool feature is engageable with a second tool to rotate the dual-end fastening bolt or to prevent the dual-end fastening bolt from rotation.

11. The dual-end fastening bolt of claim 10, wherein the first tool feature comprises a first fastening recess that receives at least a portion of the first tool, or the second tool feature comprises a second fastening recess that receives at least a portion of the second tool, or both.

12. The dual-end fastening bolt of claim 11, wherein the first fastening recess, the second fastening recess, or both, includes a hexagonal recess defined by a number of recess walls and a recess bottom surface.

13. The dual-end fastening bolt of claim 10, wherein the first tool feature comprises a first fastening post that engages at least a portion of the first tool, or the second feature comprises a second fastening post that engages at least a portion of the second tool, or both.

14. The dual-end fastening bolt of claim 13, wherein the first fastening post, the second fastening post, or both, includes a hexagonal post defined by a number of post walls and a post top surface.
